(19) United States
(12) Patent Application Publication
(10) Pub. No.: US 2008/0248374 A1
(43) Pub. Date: Oct. 9, 2008

(54) FUEL CELL, METHOD FOR PRODUCING SAME, AND ELECTRONIC DEVICE

(75) Inventors: Mamoru Hatakeyama, Kanagawa (JP); Takashi Tomita, Kanagawa (JP); Hideki Sakai, Kanagawa (JP); Atsushi Sato, Kanagawa (JP); Takaaki Nakagawa, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/104,988

(22) Filed: Apr. 17, 2008

(30) Foreign Application Priority Data
Oct. 7, 2005 (JP) 2005-295532

(51) Int. Cl. H01M 8/00

(52) U.S. Cl. 429/46; 29/623.1

(57) ABSTRACT

A fuel cell includes a positive electrode, a negative electrode, an enzyme including an oxidase that oxidizes a monosaccharide, the enzyme being immobilized on the negative electrode, an electron mediator including a compound having a naphthoquinone skeleton, the electron mediator being immobilized on the negative electrode, a coenzyme that is formed by oxidation of the monosaccharide, and a coenzyme oxidase that oxidizes the coenzyme, in which the ratio of the electron mediator to the coenzyme is in the range of 1.0 (mol):0.33 (mol) to 1.0 (mol):1.0 (mol).

### CROSS REFERENCES TO RELATED APPLICATIONS

The present application contains subject matter related to Japanese Patent Application JP 2005-295532 filed in the Japanese Patent Office on Oct. 7, 2005 and published on Apr. 19, 2007, the entire contents of which are incorporated herein by reference.

### BACKGROUND

The present application relates to a fuel cell, a method for producing the fuel cell, and an electronic device. For example, these are suitable for fuel cells each including a negative electrode on which an enzyme serving as a catalyst and an electron mediator are immobilized, and various devices, apparatuses, and systems including the fuel cells.

Hitherto, fuel cells each include a positive electrode (oxidizer electrode), a negative electrode (fuel electrode), and an electrolyte (proton conductor), the positive electrode facing the negative electrode with the electrolyte provided therebetween. Fuel (hydrogen) fed into the negative electrode is oxidized to generate protons (H⁺) and electrons. Electrons move to the negative electrode. Protons move to the positive electrode through the electrolyte. At the positive electrode, protons react with oxygen that is fed into the positive electrode from the outside and electrons that are transferred from the negative electrode through an external circuit to form water (H₂O).

Fuel cells are high-efficiency power generators that directly convert the chemical energy of fuel into electric energy. In other words, fuel cells convert the chemical energy of fossil fuel, such as natural gas, petroleum, and coal, into electric energy with high conversion efficiency regardless of time and place. Thus, research and development of fuel cells for large-scale power generation has been actively conducted. An example of successful attempts is the fuel cell mounted on the space shuttle. The fuel cell not only generates electric power but also supplies the crew with water without environmental pollution.

In recent years, fuel cells that operate at relatively low temperatures ranging from room temperature to about 90° C., e.g., polymer electrolyte fuel cells, have been developed and have been receiving attention. Attempts have been made to apply such fuel cells to small-scale power sources, such as power sources for driving automobiles and portable power sources for personal computers and mobile devices, as well as large-scale power generators.

Thus, fuel cells are attracting attention for their possible use as efficient power generators that operate on any scale. Unfortunately, fuel cells still have the following problems: Fuel cells use hydrogen gas generated from fuel, such as natural gas, petroleum, or coal, with reformers, i.e., they consume limited natural resources. Fuel cells may need heating at high temperatures and expensive catalysts of noble metals such as platinum (Pt). Furthermore, in the case where hydrogen gas and methanol are directly used as fuel, they may require careful handling.

A fuel cell based on the principle of the metabolism of living organisms, which is a highly efficient energy conversion mechanism, has been reported. The term “metabolism” includes respiration and photosynthesis that take place in cells of microorganisms. The metabolism of living organisms involves very efficient power generation and proceeds under mild conditions at room temperature.

Respiration involves intake of nutrients, such as saccharides, fats, and proteins, into microorganisms or cells, enzymatic reactions to form carbon dioxide (CO₂) through the glycolytic pathway and tricarboxylic acid (TCA) cycle, reduction to convert nicotinamide adenine dinucleotide (NAD⁺) into reduced nicotinamide adenine dinucleotide to generate oxidation-reduction energy, i.e., electric energy, direct conversion of the electric energy of NADH into the electric energy of proton gradient in the electron transport system, and reduction of oxygen into water. The resulting electric energy forms ATP from adenosine diphosphate (ADP) with adenosine triphosphate (ATP) synthetase. The resulting ATP is used for reactions required for the growth of microorganisms and cells. Such energy conversion is performed in cytosol and mitochondria.

Photosynthesis is a mechanism for generating electric energy from light energy by reduction of nicotinamide adenine dinucleotide phosphate (NADP⁺) into reduced nicotinamide adenine dinucleotide phosphate (NADPH) through the electron transport system, with evolution of oxygen by oxidation of water. The resulting electric energy is used for carbon assimilation from CO₂ and synthesis of carbohydrates.

As a technique for applying the metabolism described above to a fuel cell, for example, Japanese Unexamined Patent Application Publication No. 2000-133297 discloses a microorganism battery that supplies electric current by sending electric energy (electrons) generated by microorganisms to electrodes through an electron mediator.

However, microorganisms and cells include many unnecessary reactions other than target reactions that convert chemical energy into electric energy. Thus, the battery produced by the method described above has insufficient energy conversion efficiency because the electric energy is consumed in the unnecessary reactions.

For example, Japanese Unexamined Patent Application Publication Nos. 2003-282124, 2004-71559, and 2005-13210 disclose biofuel cells in which only target reactions are performed with enzymes. The biofuel cells have a mechanism in which fuel is decomposed by an enzyme into protons and electrons. Examples of the fuel used for the biofuel cells include alcohols such as methanol and ethanol and saccharides such as glucose.

### SUMMARY

Current biofuel cells do not have sufficient output.

It is desirable to provide a high-power fuel cell and a method for easily producing the fuel cell in an embodiment.

It is desirable to provide a negative electrode suitable for the fuel cell and a method for producing the negative electrode.

It is desirable to provide an electronic apparatus, a vehicle, a power generation system, and a cogeneration system including the above-described excellent fuel cell in an embodiment.

It is desirable to provide a high-power device utilizing an enzyme reaction, a method for producing the device, an electrode suitable for the device, and a method for producing the electrode in an embodiment.

It is desirable to provide a method for efficiently immobilizing a compound having a naphthoquinone skeleton suitable for an electron mediator on various bases such as an electrode having an immobilized enzyme in an embodiment.

The inventors have conducted intensive studies and have found that in a fuel cell (biofuel cell) including a positive electrode, a negative electrode facing the positive electrode, and a proton conductor provided between the positive electrode and the negative electrode, the negative electrode having an immobilized enzyme and electron mediator, when a compound having a naphthoquinone skeleton is used as the electron mediator, the use of acetone as a solvent used in immobilizing the compound having the naphthoquinone skeleton on the negative electrode results in the most efficient immobilization, thereby improving output. The inventors have focused attention on the optimization of the combination of the enzyme (oxidase, coenzyme oxidase, or the like), a coenzyme, and the electron mediator and the optimization of the amounts of these components and have succeeded in the optimizations, thereby improving the output.

According to an embodiment, there is provided a fuel cell including

a positive electrode,

a negative electrode,

an enzyme including an oxidase that oxidizes a monosaccharide, the enzyme being immobilized on the negative electrode,

an electron mediator including a compound having a naphthoquinone skeleton, the electron mediator being immobilized on the negative electrode,

a coenzyme that is formed by oxidation of the monosaccharide, and

a coenzyme oxidase that oxidizes the coenzyme, in which the ratio of the electron mediator to the coenzyme is in the range of 1.0 (mol):0.33 (mol) to 1.0 (mol):1.0 (mol).

Any naphthoquinone derivative may be used as the compound having the naphthoquinone skeleton contained in the electron mediator. Preferred examples thereof include 2-methyl-1,4-naphthoquinone (VK3), 2-amino-3-carboxy-1,4-naphthoquinone (ACNQ), and 2-amino-1,4-naphthoquinone (ANQ). The electron mediator may further contain one or more compounds serving as an electron mediator other than the compound having the naphthoquinone skeleton, as needed.

The enzyme immobilized on the negative electrode is selected in accordance with the fuel used. For example, in the case where a monosaccharide such as glucose is used as fuel, the enzyme is an oxidase that oxidizes and decomposes the monosaccharide. The oxidase is usually used in combination with a coenzyme oxidase which returns the coenzyme, which has been reduced by the oxidase, into its oxidized form. When this coenzyme oxidase returns the coenzyme into its oxidized form, electrons are generated. The generated electrons are transferred from the coenzyme oxidase to the electrode through the electron mediator. Examples of the oxidase include glucose dehydrogenases, preferably NAD-dependent glucose dehydrogenase (GDH). Examples of the coenzyme in the oxidized form include nicotinamide adenine dinucleotide (NAD⁺). Examples of the coenzyme oxidase include NADH dehydrogenases such as diaphorase.

In the case where a polysaccharide (which generally represents any hydrocarbon that provides two or more molecules of a mono-saccharide by hydrolysis and represents an oligosaccharide such as a di-, tri-, or tetra-saccharide) is used as fuel, the above-mentioned oxidase, coenzyme oxidase, coenzyme, and electron mediator are preferably immobilized in combination with a catabolic enzyme that promotes the decomposition (hydrolysis) of polysaccharides to give monosaccharides (such as glucose). Examples of the polysaccharide include starch, amylose, amylopectin, glycogen, cellulose, maltose, sucrose, and lactose. Each of these polysaccharides is composed of two or more monosaccharides and contains glucose as a monosaccharide serving as a bonding unit. Amylose and amylopectin are components contained in starch. Starch is a mixture of amylose and amylopectin. In the case where glucoamylase is used as the catabolic enzyme and where glucose dehydrogenase is used as the oxidase to decompose monosaccharides, the fuel used to generate electric power may be any of polysaccharides, such as starch, amylose, amylopectin, glycogen, and maltose, which are decomposed to glucose by glucoamylase. Glucoamylase is a catabolic enzyme that hydrolyzes α-glucan to give glucose. Glucose dehydrogenase is an oxidase that oxidizes β-D-glucose to D-glucono-δ-lactone. The fuel cell may have a structure such that the catabolic enzyme to decompose polysaccharides is immobilized on the negative electrode and the polysaccharide that is finally consumed as fuel is also immobilized on the negative electrode.

Starch that is consumed as fuel may be in the form of gel-like solid fuel obtained by gelatinization of starch. In this case, gelatinized starch may be brought into contact with the negative electrode having enzymes immobilized thereon or may be immobilized on the negative electrode together with enzymes. The resulting negative electrode keeps a high starch concentration on its surface compared with that of the case where starch is dissolved in a solution. This promotes enzymatic decomposition and increases output. In addition, solid fuel is easier to handle than liquid fuel and suitable for a simple fuel supply system. The fuel cell using solid fuel can operate in any position, which is advantageous when it is built into mobile equipment.

According to a preferred embodiment, the negative electrode includes 2-methyl-1,4-naphthoquinone (VK3) as an electron mediator, reduced nicotinamide adenine dinucleotide (NADH) as a coenzyme, glucose dehydrogenase as an oxidase, and diaphorase as a coenzyme oxidase immobilized thereon. Most preferably, these components are immobilized on the negative electrode in a ratio of 1.0 (mol):0.33 to 1.0 (mol):(1.8 to 3.6)×10⁶ (U):(0.85 to 1.7)×10⁷ (U).

U (unit) used herein is an index representing the enzyme activity and, for example, is determined as follows.

Diaphorase

Reaction Formula

$$NADH + DCIP ( ox . ) + {H}^{+} {}^{Diaphorase} {NAD}^{+} + DCIP ( red . )$$

The disappearance of DCIP_{(ox.)} is measured at 600 nm by spectrophotometry.

One unit is defined as the amount of enzyme that reduces 1 μmol of DCIP per minute under the conditions described below.

Reagents

Solution A: 60 mM Tris-HCl buffer (pH 8.5)

Solution B: NADH solution

β-NADH (85.1 mg) (produced by Oriental Yeast Co., Ltd.) is dissolved in deionized water (10 mL).

Solution C: 2,6-Dichlorophenolindophenol (DCIP) solution

DCIP sodium salt dihydrate (2.35 mg) is dissolved in water.

Solution D: Enzyme solution

Diaphorase “Amano” (20 mg) is dissolved in chilled deionized water.

Procedure

Solution A (2.5 mL), Solution B (0.25 mL), and Solution C (0.25 mL) are pipetted into a cuvette (d=10 mm). The resulting mixture is kept at 30±0.1° C. for 5 minutes. Solution D (0.1 mL) is pipetted into the cuvette. The resulting reaction mixture is mixed well immediately and is then kept at 30±0.1° C. Exactly at 0.5 minutes and 1.0 minute after the addition of Solution D, the absorbance of the reaction mixture is measured at 600 nm (A0.5 and A1.0). As a blank, deionized water is pipetted into another cuvette (d=10 mm) instead of Solution D, and the absorbance (Ab0.5 and Ab1.0) is measured in the same way as described above.

Calculation

The unit (U/mg) of diaphorase per weight is defined by the following formula.

$$Diaphorase activity ( U \text{/} mg ) = \frac{( A 0.5 - A 1.0 ) - ( Ab 0.5 - Ab 1.0 )}{0.5} \times \frac{1}{19.0} \times 3.10 \times \frac{Dm}{0.1}$$

0.5: Reaction time

19.0: Millimolar extinction coefficient of DCIP (at 600 nm)

3.1: Final volume of the reaction mixture

0.1: Volume of Enzyme solution

Dm: Dilution multiple of Enzyme solution

Glucose Dehydrogenase

Reaction Formula

$$β \text{-} D Glucose + {NAD}^{+} {}^{Glucose Dehydrogenase} D \text{-} Glucono \text{-} δ \text{-} lactone + NADH + {H}^{-}$$

The formation of NADH is determined by spectrophotometry at 340 nm.

One unit is defined as the amount of enzyme that produces 1 μmol of NADH per minute under the conditions described below.

Reagent

Solution A: 0.1 M Tris-HCl buffer (pH 8.0)

Solution B: 0.1 M Phosphate buffer (KH₂PO₄—Na₂HPO₄, pH 7.0)

Solution C: Substrate solution

Glucose (6.75 g) is dissolved in deionized water to form a solution (25 mL). Substrate solution is used at 30 minutes or later after preparation. Substrate solution expires in two weeks at room temperature.

Solution D: NAD solution

β-NAD (40 mg) (produced by Oriental Yeast Co., Ltd.) is dissolved in deionized water (1 mL). NAD solution expires in one week at 2° C. to 8° C.

Solution E: Enzyme solution

Glucose dehydrogenase “Amano” (20 mg) is dissolved in chilled Solution B. Enzyme solution is prepared in such a manner that the value of ΔOD/minute is in the range of 100±0.020.

Procedure

Solution A (2.7 mL), Solution C (0.2 mL), and Solution D (0.1 mL) are pipetted into a cuvette (d=10 mm). The resulting mixture is kept at 25±0.1° C. for 5 minutes. Solution E (0.05 mL) is pipetted into the cuvette. The resulting reaction mixture is mixed well immediately and is then kept at 25±0.1° C.

Exactly at 2 minute and 5 minutes after the addition of Solution E, the absorbance of the reaction mixture is measured at 340 nm (A2 and A5). As a blank, Solution B is pipetted into another cuvette (d=10 mm) instead of Solution D, and the absorbance (Ab2 and Ab5) is measured in the same way as described above.

Calculation

The unit (U/mg) of glucose dehydrogenase per weight is defined by the following formula.

$$Glucose dehydrogenase activity \\ ( u \text{/} mg ) = \frac{( A 5 - A 2 ) - ( Ab 5 - Ab 2 )}{3} \times \frac{1}{6.22} \times 3.05 \times \frac{Dm}{0.05}$$

3: Reaction time

6.22: Millimolar extinction coefficient of NADH (at 340 nm)

3.05: Final volume of the reaction mixture

0.05: Volume of Enzyme solution

Dm: Dilution multiple of Enzyme solution

An enzyme may be immobilized on the positive electrode or not. The enzyme immobilized on the positive electrode typically includes an oxidase. Examples of the oxidase include bilirubin oxidase, laccase, and ascorbic acid oxidase. In this case, the positive electrode preferably has an electron mediator immobilized thereon in addition to the enzyme. An example of the electron mediator is potassium hexacyanoferrate. The electron mediator is preferably immobilized so as to have a sufficiently high concentration, e.g., 0.64×10⁻⁶ mol/mm² or more on average.

Various materials for immobilizing the enzyme, the coenzyme, and the electron mediator on the negative electrode or the positive electrode may be used. Polyion complexes composed of either polycations, such as poly-L-lysine (PLL), or salts thereof and composed of either polyanions, such as polyacrylic acid (e.g., sodium polyacrylate (PAAcNa)), or salts thereof may be preferably used. The polyion complexes can contain the enzyme, the coenzyme, the electron mediator, and the like.

A carbonaceous material that has been used in the past may be used for the positive electrode or the negative electrode. Alternatively, a porous conducting component including a skeleton formed of a porous element and a coating layer composed of a carbonaceous material covering at least part of the skeleton may also be used. The porous conducting component is prepared by coating at least part of the surface of the skeleton formed of the porous element with a material composed mainly of a carbonaceous material. Any porous element for constituting the skeleton of the porous conducting component may be used as long as the porous element can sufficiently stably maintain the skeleton and is highly porous. The porous element may or may not be electrically conductive. The porous element preferably has a high porosity and a high conductivity. Specifically, such a porous element having a high porosity and a high conductivity may be composed of, for example, a metallic material, e.g., a metal or an alloy, or a carbonaceous material having a reinforced skeleton for improved brittleness. In the case where a porous metallic material is used, the metallic material is appropriately selected from many alternatives in view that the stability of metallic materials depends on the environment, such as the pH of a solution and the potential. Examples of the metallic material readily available include foamed metals and alloys of nickel, copper, silver, gold, nickel-chrome alloys, and stainless steel. The porous element may also be composed of a resin material (for example, in the form of a sponge) other than the foregoing metallic and carbonaceous materials. The porosity and the pore diameter (minimum pore diameter) of the porous element are determined in response to the porosity and the pore diameter that may be required for the porous conducting component and in view of the thickness of a layer which covers the surface of the skeleton of the porous element and which is mainly composed of a carbonaceous material. The porous element usually has a pore diameter of 10 nm to 1 mm and typically 10 nm to 600 μm. The material covering the surface of the skeleton should be conductive and stable at an assumed operating potential. A material composed mainly of a carbonaceous material is used herein. This is because carbonaceous materials generally have a wide potential window and good chemical stability. Examples of the material composed mainly of the carbonaceous material include a material consisting of a carbonaceous material; and a material mainly containing a carbonaceous material and containing a small amount of an auxiliary material selected in response to the properties that may be required for the porous conducting component. Examples of the auxiliary material include highly conductive materials such as metals that increase the electrical conductivity of the carbonaceous material; and polytetrafluoroethylene materials that impart water repellency, which is a function other than conductivity, to the carbonaceous material. Any of various carbonaceous materials may be used. Elemental carbon may be used. The carbonaceous material may contain an additional element. In particular, the carbonaceous material is preferably composed of a fine carbon powder having a high conductivity and a high surface area. Examples of the preferred carbonaceous material include high-conductivity carbon materials such as Ketjen Black (KB); and functional carbon materials such as carbon nanotubes and fullerenes. Any method for applying the carbonaceous material to the surface of the skeleton formed of the porous element may be employed optionally with an appropriate binder. The porous conducting component has a pore diameter such that a solution containing a substrate passes easily through the pores. The pore diameter is in the range of 9 nm to 1 mm, preferably 1 μm to 1 mm, and more preferably 1 to 600 μm. The coating on the porous skeleton with the carbonaceous material should be made such that it keeps all pores open without clogging.

In the case where an electrolyte containing a buffer material is used as a proton conductor, in order to provide a sufficient buffer capacity and fully exhibit the inherent ability of the enzyme during high-power operation, the concentration of the buffer material in the electrolyte is effectively in the range of 0.2 M to 2.5 M, preferably 0.2 M to 2 M, more preferably 0.4 M to 2 M, and still more preferably 0.8 M to 1.2 M. Any buffer material may be used as long as it has a pKa value of 6 to 9. Examples of the buffer material include dihydrogen phosphate ions (H₂PO₄⁻), 2-amino-2-hydroxymethyl-1,3-propanediol (Tris for short), 2-(N-morpholino)ethanesulfonic acid (MES), cacodylic acid, carbonic acid (H₂CO₃), hydrogen citrate ions, N-(2-acetamido) iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (Tricine for short), glycylglycine, and N,N-bis(2-hydroxyethyl)glycine (Bicine for short). Examples of a material that generates dihydrogen phosphate ions (H₂PO₄⁻) include sodium dihydrogen phosphate (NaH₂PO₄) and potassium dihydrogen phosphate (KH₂PO₄). The buffer-containing electrolyte preferably has a pH value of about 7. In general, the buffer-containing electrolyte may have a pH value of 1 to 14.

The fuel cell may be variable in size and applicable to devices and the like that use electric power, such as electronic devices, vehicles, power plants, construction machines, machine tools, power-generation systems, and cogeneration systems. The output, size, and shape of the fuel cell and the type of fuel are determined in response to the application.

According to another embodiment, there is provided a method for producing a fuel cell that includes

a positive electrode,

a negative electrode,

an enzyme including an oxidase that oxidizes a monosaccharide, the enzyme being immobilized on the negative electrode,

an electron mediator including a compound having a naphthoquinone skeleton, the electron mediator being immobilized on the negative electrode,

a coenzyme that is formed by oxidation of the monosaccharide, and

a coenzyme oxidase that oxidizes the coenzyme, the method including the step of immobilizing the electron mediator on the negative electrode in such a manner that the ratio of the electron mediator to the coenzyme is in the range of 1.0 (mol):0.33 (mol) to 1.0 (mol):1.0 (mol).

According to another embodiment, there is provided a method for producing a fuel cell that includes

a positive electrode,

a negative electrode,

an enzyme including an oxidase that oxidizes a monosaccharide, the enzyme being immobilized on the negative electrode,

an electron mediator including a compound having a naphthoquinone skeleton, the electron mediator being immobilized on the negative electrode,

a coenzyme that is formed by oxidation of the monosaccharide, and

a coenzyme oxidase that oxidizes the coenzyme, the method including the step of immobilizing the enzyme on the negative electrode in such a manner that the ratio of the oxidase to the coenzyme oxidase is (1.8 to 3.6)×10⁶ (U):(0.85 to 1.7)×10⁷ (U).

According to another embodiment, there is provided an electronic device including

a fuel cell including

a positive electrode,

a negative electrode,

an enzyme including an oxidase that oxidizes a monosaccharide, the enzyme being immobilized on the negative electrode,

an electron mediator including a compound having a naphthoquinone skeleton, the electron mediator being immobilized on the negative electrode,

a coenzyme that is formed by oxidation of the monosaccharide, and

a coenzyme oxidase that oxidizes the coenzyme, in which the ratio of the electron mediator to the coenzyme is in the range of 1.0 (mol):0.33 (mol) to 1.0 (mol):1.0 (mol).

The electronic device is not specifically restricted. The electronic device may be portable or stationary. Examples thereof include mobile phones, mobile equipment, robots, personal computers, game machines, vehicle equipment, household appliances, and industrial products.

Additional features and advantages are described herein, and will be apparent from the following Detailed Description and the figures.

### BRIEF DESCRIPTION OF THE FIGURES

FIG. 1 is a schematic diagram illustrating a biofuel cell according to a first embodiment;

FIG. 2 is a schematic diagram illustrating a detailed structure of a negative electrode of the biofuel cell according to the first embodiment, exemplary enzymes immobilized on the negative electrode, and electron transfer reactions with the enzymes;

FIG. 3 is a schematic diagram illustrating a system of electrochemical measurement of a single electrode having an enzyme, a coenzyme, and an electron mediator immobilized thereon, the electrode being used for the negative electrode of the biofuel cell according to the first embodiment;

FIG. 4 is a graph showing the relationship between the amount of VK3 and the current measured by electrochemical measurement of a single electrode having an enzyme, a coenzyme, and an electron mediator immobilized thereon, the electrode being used for the negative electrode of the biofuel cell according to the first embodiment;

FIG. 5 is a graph showing the relationship between the amount of VK3 and the current measured by electrochemical measurement of a single electrode having an enzyme, a coenzyme, and an electron mediator immobilized thereon, the electrode being used for the negative electrode of the biofuel cell according to the first embodiment;

FIG. 6 is a graph showing the relationship between the amount of NADH and the current measured by electrochemical measurement of a single electrode having an enzyme, a coenzyme, and an electron mediator immobilized thereon, the electrode being used for the negative electrode of the biofuel cell according to the first embodiment;

FIG. 7 is a graph showing the relationship between the amount of GDH and the current measured by electrochemical measurement of a single electrode having an enzyme, a coenzyme, and an electron mediator immobilized thereon, the electrode being used for the negative electrode of the biofuel cell according to the first embodiment;

FIG. 8 is a cyclic voltammogram of the electrode having optimized amounts of an enzyme, a coenzyme, and an electron mediator immobilized thereon, the electrode being used for the negative electrode of the biofuel cell according to the first embodiment;

FIGS. 9A and 9B are schematic diagrams each illustrating the structure of the biofuel cell according to the first embodiment;

FIGS. 10A and 10B are a schematic diagram and a cross-sectional view, respectively, each illustrating the structure of a porous conducting component used for a negative electrode of a biofuel cell according to a second embodiment; and

FIGS. 11A and 11B are schematic diagrams illustrating a method for producing the porous conducting component used for the negative electrode of the biofuel cell according to the second embodiment.

### DETAILED DESCRIPTION

Embodiments will be described with reference to the accompanying drawings.

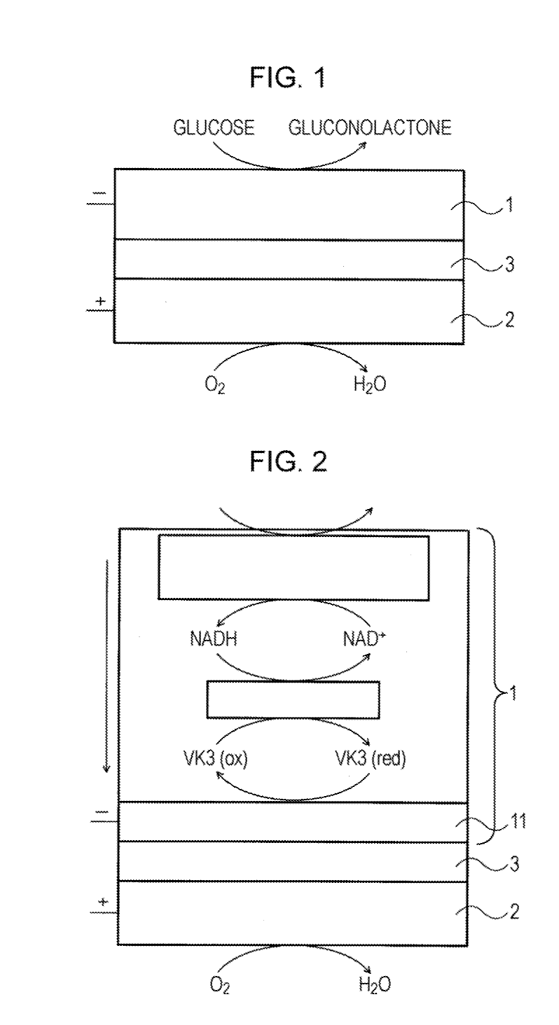

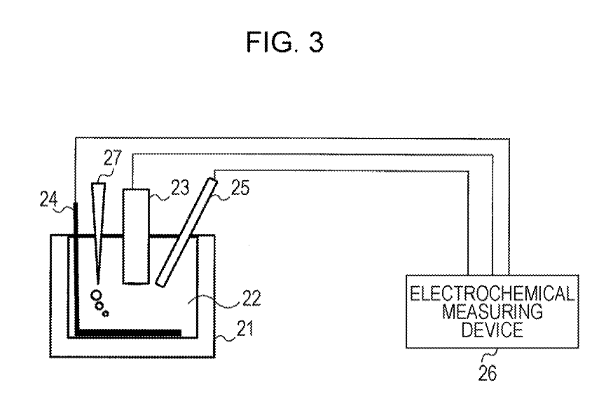

FIG. 1 schematically shows a biofuel cell according to a first embodiment. In this biofuel cell, glucose is used as fuel. FIG. 2 is a schematically shows a detailed structure of a negative electrode of the biofuel cell, exemplary enzymes immobilized on the negative electrode, and electron transfer reactions with the enzymes.

As shown in FIG. 1, the biofuel cell has a structure in which a negative electrode 1 faces a positive electrode 2 with a proton conductor 3 provided therebetween. At the negative electrode 1, glucose supplied as fuel is decomposed by an enzyme to generate protons (H⁺) and electrons. At the positive electrode 2, water is formed from protons transferred from the negative electrode 1 through the proton conductor 3, electrons transferred from the negative electrode 1 through an external circuit, and, for example, oxygen in air.

The negative electrode 1 includes an enzyme responsible for the decomposition of glucose, a coenzyme (e.g., NAD⁺) transformed into the reduced form by oxidation in the glucose decomposition process, a coenzyme oxidase (e.g., diaphorase) that oxidizes the reduced coenzyme (e.g., NADH), and an electron mediator (e.g., VK3) that transfers electrons generated by oxidation of the coenzyme from the coenzyme oxidase to a subelectrode 11 (see FIG. 2) composed of, for example, porous carbon, the enzyme, the coenzyme, the coenzyme oxidase, and the electron mediator being immobilized on the subelectrode 11 with an immobilizer (not shown) composed of, for example, a polyion complex containing a polycation such as poly-L-lysine (PLL) and a polyanion such as sodium polyacrylate (PAAcNa).

Examples of the enzyme responsible for decomposing glucose include glucose dehydrogenase (GDH) and preferably NAD-dependent glucose dehydrogenase. The presence of this oxidase oxidizes β-D-glucose into D-glucono-δ-lactone.

The resulting D-glucono-δ-lactone is decomposed into 2-keto-6-phospho-D-gluconate in the presence of two enzymes: gluconokinase and phosphogluconate dehydrogenase (PhGDH). In other words, D-glucono-δ-lactone is converted into D-gluconate by hydrolysis. The resulting D-gluconate is subjected to phosphorylation to form 6-phospho-D-gluconate when adenosine triphosphate (ATP) is decomposed by hydrolysis into adenosine diphosphate (ADP) and phosphoric acid in the presence of glucokinase. The resulting 6-phospho-D-gluconate is oxidized into 2-keto-6-phospho-D-gluconate by the oxidase (PhGDH).

Glucose may also undergo glucose metabolism to decompose into CO₂ in addition to the above-described decomposition process. The decomposition process based on the glucose metabolism is divided into three categories: decomposition of glucose through glycolytic pathway, formation of pyruvic acid, and TCA cycle, which are well-known reaction systems.

An oxidation reaction in the decomposition process of a monosaccharide involves a reduction reaction of a coenzyme that is specific for an enzyme on which the coenzyme acts. For example, a coenzyme for GDH is NAD⁺. That is, GDH acts on β-D-glucose for oxidation into D-glucono-δ-lactone. This oxidation reaction reduces NAD⁺ into NADH, thereby generating protons (H⁺).

The resulting NADH is immediately oxidized into NAD⁺ in the presence of diaphorase (DI), thereby producing two electrons and two protons. In other words, one molecule of glucose yields two electrons and two protons in a single oxidation step. In two oxidation steps, four electrons and four protons are produced in total.

The electrons generated in the process described above are transferred from diaphorase to the subelectrode 11 through the electron mediator. The resulting protons are transferred to the positive electrode 2 through the proton conductor 3.

The enzyme, the coenzyme, and the electron mediator are preferably maintained at an optimum pH value (e.g., about 7) with a buffer, such as a phosphate buffer or Tris buffer) in order that the electrode reaction proceeds efficiently and constantly. An example of the phosphate buffer is a solution of NaH₂PO₄ and KH₂PO₄. The ionic strength (I.S.) is preferably about, for example, 0.3 in view of electrochemical responsiveness. An excessively high or low ionic strength adversely affects the enzyme activity. However, the pH and the ionic strength are not limited to the above-described values because the optimum values of the pH and the ionic strength depend on the enzymes used.

FIG. 2 shows an exemplary negative electrode including glucose dehydrogenase (GDH) serving as the enzyme responsible for the decomposition of glucose, NAD⁺ serving as the coenzyme transformed into the reduced form by oxidation in the glucose decomposition process, diaphorase (DI) serving as the coenzyme oxidase that oxidizes NADH, which is the coenzyme in the reduced form, and VK3 serving as the electron mediator that transfers electrons generated by oxidation of the coenzyme from the coenzyme oxidase to a subelectrode 11.

The positive electrode 2 is formed of a carbon powder supporting a catalyst or catalyst particles not supported on carbon. Examples of the catalyst include fine platinum (Pt) particles; fine particles of alloys of platinum and transition metals, such as iron (Fe), nickel (Ni), cobalt (Co), and ruthenium (Ru); and oxide particles. For example, the positive electrode 2 includes a catalyst layer composed of a catalyst or a catalyst-containing carbon powder; and a gas-diffusion layer composed of a porous carbon material, the catalyst layer and the gas-diffusion layer being stacked in that order from the proton conductor 3. The positive electrode 2 is not limited to this structure. Alternatively, an oxidoreductase may be used as the catalyst. In this case, the oxidoreductase is used in combination with the electron mediator that transfers electrons between the electrodes.

At the positive electrode 2, water is produced by reducing oxygen in air by means of protons transferred from the proton conductor 3 and electrons transferred from the negative electrode 1 in the presence of the catalyst.

The proton conductor 3 serves to transfer protons generated at the negative electrode 1 to the positive electrode 2. The proton conductor 3 is composed of a material that does not have electron conductivity but have proton conductivity. Specifically, the proton conductor 3 is a film composed of, for example, a perfluorocarbonsulfonate (PFS) resin, a trifluorostyrene derivative copolymer, polybenzimidazole impregnated with phosphoric acid, aromatic polyether ketone sulfonic acid, a polystyrenesulfonic acid-polyvinyl alcohol (PSSA-PVA) copolymer, or a polystyrenesulfonic acid-ethylene vinyl alcohol (PSSA-EVOH) copolymer. Among these, the proton conductor 3 is preferably composed of an ion-exchange resin having fluorine-containing carbon sulfonic acid groups. Specifically, Nafion (trade name, produced by DuPont in the US) is used.

The biofuel cell having the structure described above works as follows: when the negative electrode 1 is supplied with glucose, glucose is decomposed by the catabolic enzyme containing the oxidase. Since the oxidase participates in the decomposition process of a monosaccharide, electrons and protons can be formed on the negative electrode 1 side, thus generating a current between the negative electrode 1 and the positive electrode 2.

Experiments were designed to optimize the amounts of components of an electrode having the enzyme, the coenzyme, and the electron mediator immobilized thereon, the electrode being used as the negative electrode 1. The optimization was performed in the order of proximity to the subelectrode 11. The results will be described below.

Experiment 1

FIG. 3 shows a system of electrochemical measurement of a single electrode having an enzyme, a coenzyme, and an electron mediator immobilized thereon, the electrode being used for the negative electrode 1. As shown in FIG. 3, a measurement solution 22 was charged into a vessel 21. A working electrode 23, a counter electrode 24, and a reference electrode 25 were immersed in the measurement solution 22 and connected to an electrochemical measuring device 26. As the measurement solution 22, a buffer (0.1 M NaH₂PO₄—NaOH—NaCl, I.S. (ionic strength)=0.3, pH: 7) was used. The working electrode 23 included VK3, diaphorase (DI), NADH, and glucose dehydrogenase (GDH) immobilized on a glassy carbon disk electrode (diameter: 3 mm, 0.071 cm²) with a polyion complex composed of poly-L-lysine (PLL) and sodium polyacrylate (PAAcNa) as an immobilizer. As the counter electrode 24, Pt wire was used. As the reference electrode 25, Ag|AgCl was used. Measurement was performed at atmospheric pressure and a temperature of 25° C. The amount of the measurement solution 22 was set at 1 mL. The measurement solution 22 was deoxygenated by sufficiently bubbling Ar gas with a bubbler 27 before measurement.

The electrode having the enzyme, the coenzyme, and the electron mediator immobilized thereon was formed as follows.

First, various solutions were prepared as follows. The measurement solution 22 was used as a buffer.

GDH/DI/NADH Enzyme-Coenzyme Buffer ((1))

Diaphorase (DI) (10 mg) (EC 1.6.99.-, DH “Amano” 3, manufactured by Amano Enzyme Inc.) was dissolved in a buffer (1 mL) to prepare a solution ((1)′). The buffer that dissolves the enzyme is preferably stored at 8° C. or lower until just before the buffer was used. Also, the resulting enzyme buffer is preferably stored at 8° C. or lower.

Glucose dehydrogenase (GDH) (13.8 mg) (NAD-dependent, EC 1.1.1.47, GDH-2, manufactured by Amano Enzyme Inc.) and NADH (40 mg) (N-8129, manufactured by Sigma-Aldrich Corporation) were dissolved in a buffer (1 mL). The solution (1)′ (20 μL) was added thereto and mixed sufficiently.

Aqueous Solution of PLL ((2))

A proper amount of poly-L-lysine hydrobromate (PLL) (P-2636, manufactured by Sigma-Aldrich Corporation) was dissolved in deionized water in such a manner that a 1 wt % solution was prepared.

Ethanol Solution of VK3 ((3))

A predetermined amount of 2-methyl-1,4-naphthoquinone (VK3) (36405-84, manufactured by Nacalai Tesque, Inc.) was dissolved in ethanol (1 mL). The amounts of VK3 were set at four levels: 16.6 mg, 33.2 mg, 49.8 mg, and 66.4 mg.

Aqueous Solution of PAAcNa ((4))

A proper amount of sodium polyacrylate (PAAcNa) (041-00595, manufactured by Sigma-Aldrich Corporation) was dissolved in deionized water in such a manner that a 1 wt % solution was prepared.

Each of the resulting solutions described above was added dropwise in an amount described below onto a glassy carbon disk electrode (002012, manufactured by BAS, diameter: 3 mm, 0.071 cm²) with a micropipette in the following order. The resulting mixture was mixed and dried at room temperature or 40° C. or lower to prepare an electrode having the enzyme, the coenzyme, and the electron mediator immobilized thereon.

GDH/DI/NADH enzyme-coenzyme buffer ((1)): 10 μL

Aqueous solution of PLL ((2)): 10 μL

Ethanol solution of VK3 ((3)): 4 μL

Aqueous solution of PAAcNa ((4)): 4 μL

The resulting mixed solution of the four solutions described above contained 4.2 U of GDH, 20 U of DI, 0.77 μmol of NADH, 2.56 fmol of PLL (M=39,000), and 0.50 fmol of PAAc (M=8,000). VK3 was contained in an amount of 0.77 μmol, 1.54 μmol, 2.31 μmol, or 3.08 μmol in accordance with the four levels.

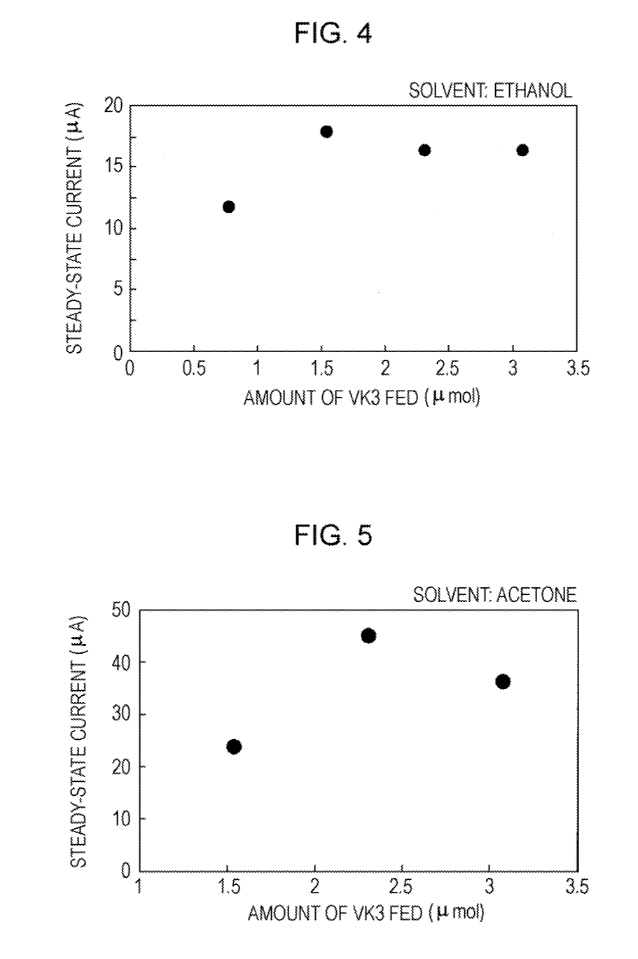

FIG. 4 is a graph showing the relationship between the amount of VK3 and the current measured by electrochemical measurement when 800 mM of glucose was added in the measurement solution 22, provided that the measurement potential was set at 0.8 V. As shown in FIG. 4, the current obtained when the amount of VK3 was 1.54 μmol or more, which was equal to or more than twice the 0.77 μmol, was about 1.3 or more times the current obtained when the amount of VK3 was 0.77 μmol. In particular, when the amount of VK3 was 1.54 μmol, the maximum current was obtained and was about 1.5 times.

Experiment 2

Various solutions were prepared as follows. The measurement solution 22 was used as a buffer.

Acetone was used as a solvent for dissolving VK3 in place of ethanol. A predetermined amount of VK3 (36405-84, manufactured by Nacalai Tesque, Inc.) was dissolved in acetone (1 mL) to prepare an acetone solution of VK3 ((5)). The amounts of VK3 were set at three levels: 33.2 mg, 49.8 mg, and 66.4 mg.

The GDH/DI/NADH enzyme-coenzyme buffer ((1)), the aqueous solution of PLL ((2)), and the aqueous solution of PAAcNa ((4)) were prepared as in Experiment 1.

Each of the resulting solutions described above was added dropwise in an amount described below onto a glassy carbon disk electrode (002012, manufactured by BAS, diameter: 3 mm, 0.071 cm²) with a micropipette in the following order. The resulting mixture was mixed and dried at room temperature or 40° C. or lower to prepare an electrode having the enzyme, the coenzyme, and the electron mediator immobilized thereon.

GDH/DI/NADH enzyme-coenzyme buffer ((1)): 10 μL

Aqueous solution of PLL ((2)): 10 μL

Acetone solution of VK3 ((5)): 4 μL

Aqueous solution of PAAcNa ((4)): 4 μL

The resulting mixed solution of the four solutions described above contained 4.2 U of GDH, 20 U of DI, 0.77 μmol of NADH, 2.56 fmol of PLL (M=39,000), and 0.50 fmol of PAAc (M=8,000). VK3 was contained in an amount of 1.54 μmol, 2.31 μmol, or 3.08 μmol in accordance with the three levels.

FIG. 5 is a graph showing the relationship between the amount of VK3 and the current measured by electrochemical measurement when 800 mM of glucose was added in the measurement solution 22, provided that the measurement potential was set at 0.8 V. As shown in FIG. 5, at the same amount of VK3, the current obtained when acetone was used as the solvent for dissolving VK3 was about 1.3 or more times the current obtained when ethanol was used as the solvent (FIG. 4). In particular, when the amount of VK3 was 2.31 μmol, the maximum current was obtained and was about 2.8 times. The reason for this is as follows: In the case where ethanol was used as the solvent for dissolving VK3, a large amount of the solvent was used because of low solubility of VK3. VK3 spread over portions of the electrode surface other than portions on which GDH, DI, and NADH were immobilized, thus resulting in low immobilization efficiency. In contrast, in the case where acetone was used as the solvent for dissolving VK3, the solubility of VK3 in acetone was about six times higher than that in ethanol, thus significantly reducing the amount of solvent. This results in a marked suppression of the spread of VK3 and a significant increase in the immobilization efficiency of VK3.

Experiment 3

Various solutions were prepared as follows. The measurement solution 22 was used as a buffer.

GDH/DI Enzyme Buffer ((6))

GDH (13.8 mg) and DI (40 mg) were dissolved in a buffer (1 mL).

NADH Coenzyme Buffer ((7))

A predetermined amount of NADH was dissolved in a buffer (1 mL). The amounts of NADH were set at four levels: 40 mg, 80 mg, 160 mg, and 320 mg.

Acetone Solution of VK3 ((5))

Acetone was used as a solvent for dissolving VK3 in place of ethanol as in Experiment 2, except that the concentration was set at 50 mg/mL.

The aqueous solution of PLL ((2)) and the aqueous solution of PAAcNa ((4)) were prepared as in Experiment 1.

Each of the resulting solutions described above was added dropwise in an amount described below onto a glassy carbon disk electrode (002012, manufactured by BAS, diameter: 3 mm, 0.071 cm²) with a micropipette in the following order. The resulting mixture was mixed and dried at room temperature or 40° C. or lower to prepare an electrode having the enzyme, the coenzyme, and the electron mediator immobilized thereon.

GDH/DI enzyme buffer ((6)): 8 μL

NADH coenzyme buffer ((7)): 2 μL

Aqueous solution of PLL ((2)): 10 μL

Acetone solution of VK3 ((5)): 4 μL

Aqueous solution of PAAcNa ((4)): 4 μL

The resulting mixed solution of the five solutions described above contained 4.2 U of GDH, 20 U of DI, 2.56 fmol of PLL (M=39,000), 2.31 μmol of VK3, and 0.50 fmol of PAAc (M=8,000). NADH was contained in an amount of 0.77 μmol, 1.54 μmol, 3.08 μmol, or 6.16 μmol in accordance with the four levels.

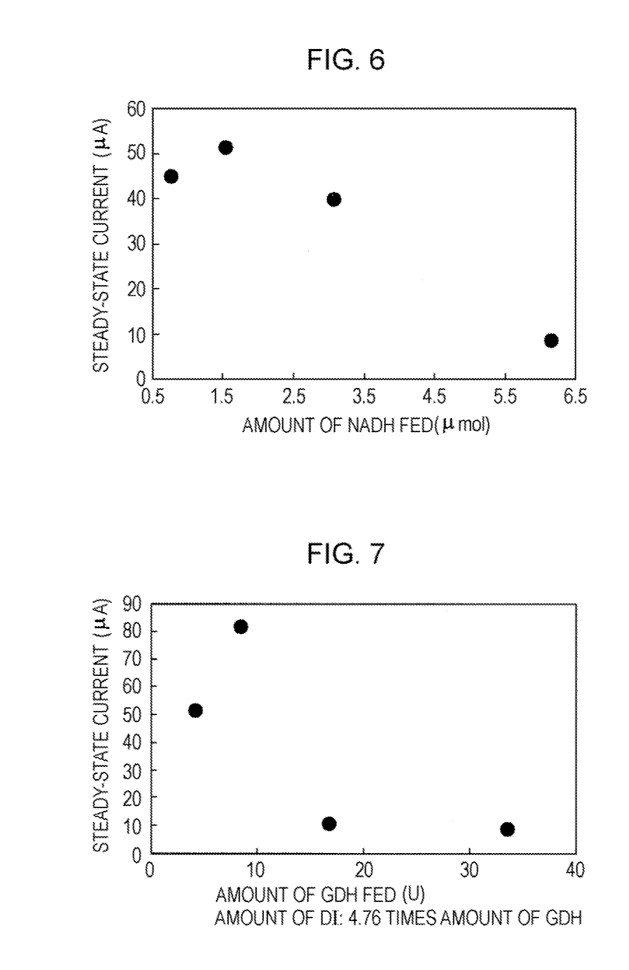

FIG. 6 is a graph showing the relationship between the amount of NADH and the current measured by electrochemical measurement when 400 mM of glucose was added in the measurement solution 22, provided that the measurement potential was set at 0.8 V. As shown in FIG. 6, an increased amount of NADH compared with that in Experiment 1 increased the current. When 6.16 μmol of NADH was added, however, a significant reduction in current was observed. This may be because an increase in the amount of hydrophilic NADH in the immobilized layer allows the entire layer to be hydrophilic, so that the layer was dissolved in the fuel solution (glucose solution). The results demonstrated that the optimal amount of NADH was in the range of 0.77 to 2.31 μmol with respect to 2.31 μmol of VK3. In other words, when the VK3:NADH ratio was in the range of 1.0 (mol):0.33 (mol) to 1.0 (mol):1.0 (mol), the resulting current was increased.

Experiment 4

Various solutions were prepared as follows. The measurement solution 22 was used as a buffer.

GDH/DI Enzyme Buffer ((8))

Predetermined amounts of GDH and DI were dissolved in a buffer (1 mL). The amounts of GDH were set at four levels: 13.8 mg, 27.6 mg, 55.2 mg, and 110.4 mg. The amounts of DI were set at four levels: 40 mg, 80 mg, 160 mg, and 320 mg.

NADH Coenzyme Buffer ((7))

NADH buffer solutions were prepared as in Experiment 3, except that the concentration was set at 80 mg/mL.

Acetone Solution of VK3 ((5))

Acetone was used as a solvent for dissolving VK3 in place of ethanol as in Experiment 2, except that the concentration was set at 50 mg/mL.

The aqueous solution of PLL ((2)) and the aqueous solution of PAAcNa ((4)) were prepared as in Experiment 1.

Each of the resulting solutions described above was added dropwise in an amount described below onto a glassy carbon disk electrode (002012, manufactured by BAS, diameter: 3 mm, 0.071 cm²) with a micropipette in the following order. The resulting mixture was mixed and dried at room temperature or 40° C. or lower to prepare an electrode having the enzyme, the coenzyme, and the electron mediator immobilized thereon.

GDH/DI enzyme buffer ((8)): 8 μL

NADH coenzyme buffer ((7)): 2 μL

Aqueous solution of PLL ((2)): 10 μL

Acetone solution of VK3 ((5)): 4 μL

Aqueous solution of PAAcNa ((4)): 4 μL

The resulting mixed solution of the five solutions described above contained 1.54 μmol of NADH, 2.56 fmol of PLL (M=39,000), 2.31 μmol of VK3, and 0.50 fmol of PAAc (M=8,000). GDH was contained in an amount of 4.2 U, 8.4 U, 16.8 U, or 33.6 U in accordance with the four levels. DI was contained in an amount of 20 U, 40 U, 80 U, and 160 U in accordance with the four levels.

FIG. 7 is a graph showing the relationship between the amount of enzymes (GDH and DI) and the current measured by electrochemical measurement when 400 mM of glucose was added in the measurement solution 22, provided that the amount of DI was 4.76 times the amount of GDH and that the measurement potential was set at 0.8 V. As shown in FIG. 7, the current was increased until the amount of GDH was twice the amount of GDH in Experiment 1 (GDH: 4.2 U, DI: 20 U). However, the current was reduced when the amount of GDH exceeded the amount. This may be because an increase in the proportion of the hydrophilic enzymes in the immobilized layer allows the layer components to be dissolved in the fuel solution (glucose solution), as in Experiment 3.

The results demonstrated that the optimum ratio of GDH:DI was in the range of 4.2 to 8.4 (U):20 to 40 (U) with respect to 2.31 μmol of VK3. When VK3:NADH:GDH:DI=1.0 (mol):0.33 to 1.0 (mol):(1.8 to 3.6)×10⁶ (U):(0.85 to 1.7)×10⁷ (U), the resulting current was maximized.

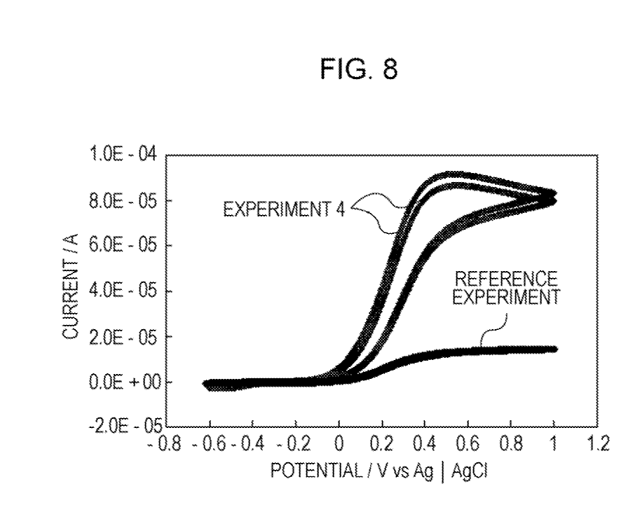

FIG. 8 is an exemplary cyclic voltammogram obtained when optimized amounts of VK3, NADH, GDH, and DI in Experiment 4 were used. Experiment 4 was compared with Experiment 1 (reference experiment), in which ethanol was used as the solvent for VK3 and the amount of VK3 was 0.77 μmol. The current in Experiment 4 was 81 μA, and the current in Experiment 1 was 12 μA at 0.8 V. That is, the current in Experiment 4 was 6.75 times the current in Experiment 1. This may be because the optimization of the amounts of the enzyme, the coenzyme, and the electron mediator allows the subelectrode 11 to receive more electrons, so that the negative electrode 1 had a significantly improved ability to obtain energy from glucose as fuel. The properties of the negative electrode 1 of the biofuel cell are markedly improved if these components, i.e., the enzyme, the coenzyme, and the electron mediator, immobilized on the negative electrode 1 work efficiently to supply the subelectrode 11 with more electrons. The amounts of these components that supplied the subelectrode 11 with electrons were optimized in the order of proximity to the subelectrode 11, i.e., from the electron mediator, thereby maximizing the output of the biofuel cell.

An exemplary structure of a biofuel cell will be described below.

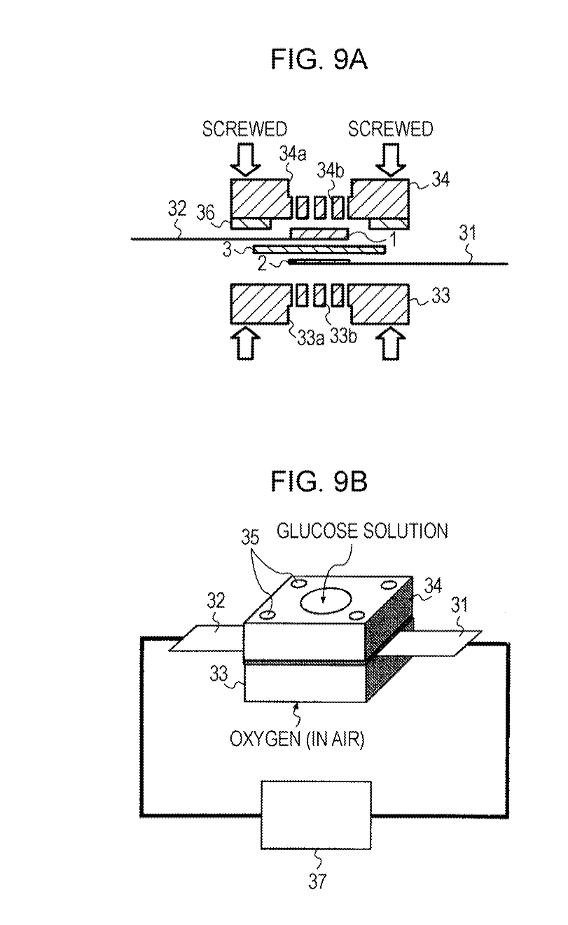

As shown in FIGS. 9A and 9B, for example, the biofuel cell includes the negative electrode 1 formed of a carbon electrode in which an enzyme, a coenzyme, and an electron mediator are immobilized on carbon felt (for example, area: 0.25 cm²) with an immobilizer; the positive electrode 2 formed of a carbon electrode in which an enzyme and an electron mediator are immobilized on carbon felt (for example, area: 0.25 cm²) with an immobilizer; and the proton conductor 3, the negative electrode 1 facing the positive electrode 2 with the proton conductor 3 provided therebetween. In this case, a Ti collector 31 is disposed under the positive electrode 2, and a Ti collector 32 is disposed on the negative electrode 1, thus facilitating current collection. Reference numerals 43 and 44 designate clamp plates 33 and 34. The clamp plates 33 and 34 are fastened to each other with screws 35. The positive electrode 2, the negative electrode 1, the proton conductor 3, and the Ti collectors 31 and 32 are disposed between the clamp plates 33 and 34. A circular depression 33a for air intake is provided on one side (outer side) of the clamp plate 33. The circular depression 33a has many through holes 33b. The holes 33b serve as air-feed channels to the positive electrode 2. A circular depression 34a for fuel intake is provided on one side (outer side) of the clamp plate 34. The circular depression 34a has many through holes 34b. The holes 34b serve as fuel-feed channels to the negative electrode 1. A spacer 36 is provided at the periphery of another side of the clamp plate 34 in order that the clamp plates 33 and 34 fastened with the screws 35 have a predetermined interval therebetween.

As shown in FIG. 9B, a load 37 is connected to the Ti collectors 31 and 32. For example, a glucose solution is charged as a fuel into the circular depression 34a of the clamp plate 34 to perform power generation.

A biofuel cell according to a second embodiment will be described below.

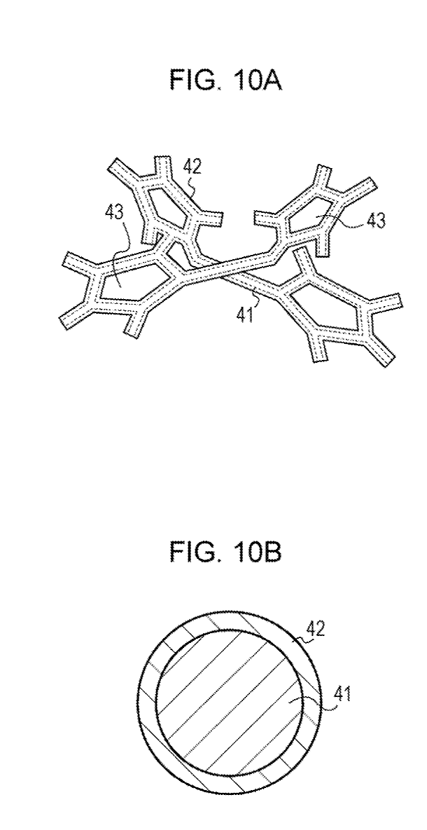

The biofuel cell according to the second embodiment has the same structure as the biofuel cell in the first embodiment, except that the subelectrode 11 of the negative electrode 1 is formed of a porous conducting component as shown in FIGS. 10A and 10B.

FIG. 10A schematically shows the structure of the porous conducting component. FIG. 10B is a cross-sectional view of the skeleton of the porous conducting component. As shown in FIGS. 10A and 10B, the porous conducting component includes a skeleton 41 formed of a porous element having a three-dimensional network structure; and a coating layer composed of a carbonaceous material 42 covering the surface of the skeleton 41. The porous conducting component has a three-dimensional network structure in which many pores 43 surrounded by the carbonaceous material 42 correspond to the networks. In this case, the pores 43 communicate with one another. The carbonaceous material 42 may have any shape, i.e., the carbonaceous material 42 may be fibrous (acicular) or granular.

The porous element constituting the skeleton 41 is composed of a foamed metal, such as foamed nickel, or a foamed alloy. The skeleton 41 generally has a porosity of 85% or more and more generally 90% or more. For example, the diameter of each of the pores of the skeleton 41 is generally in the range of 10 nm to 1 mm, more generally 10 nm to 600 μm, still more generally 1 to 600 μm, typically 50 to 300 μm, and more typically 100 to 250 μm. Preferably, the carbonaceous material 42 is a high-conductivity carbon material such as Ketjen Black. Alternatively, a functional carbon material, e.g., carbon nanotubes or fullerene may be used.

The porous conducting component generally has a porosity of 80% or more and more generally 90% or more. For example, the diameter of each of the pores 43 is generally in the range of 9 nm to 1 mm, more generally 9 nm to 600 μm, still more generally 1 to 600 μm, typically 30 to 400 μm, and more typically 80 to 230 μm.

A method for producing the porous conducting component will be described below.

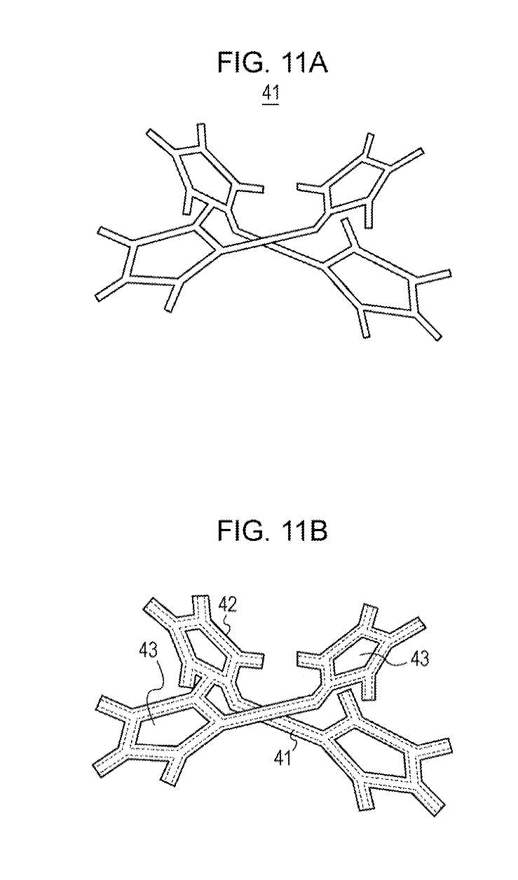

As shown in FIG. 11A, the skeleton 41 composed of a foamed metal such as foamed nickel or a foamed alloy is prepared.

As shown in FIG. 11B, the surface of the skeleton 41 composed of the foamed metal or the foamed alloy is coated with the carbonaceous material 42 by any coating method. For example, an emulsion containing a carbon powder and an appropriate binder is sprayed on the surface of the skeleton 41 to cover the skeleton 41 with the carbonaceous material 42. The coating thickness of the carbonaceous material 42 is determined in response to the porosity and the pore diameter that may be required for the porous conducting component and in view of the porosity and the pore diameter of the skeleton 41 composed of the foamed metal or the foamed alloy. The coating is performed in such a manner that a large number of the pores 43 surrounded by the carbonaceous material 42 communicate with one another.

Thereby, the target porous conducting component is produced.

According to the second embodiment, the porous conducting component including the skeleton 41 composed of a foamed metal or a foamed alloy and a coating layer composed of the carbonaceous material 42 covering the surface of the skeleton 41 has the pores 43 with sufficiently large diameters, a coarse three-dimensional network structure, a high strength, a high electrical conductivity, and a sufficiently large surface area. The negative electrode 1 is prepared by forming the subelectrode 11 using the porous conducting component and immobilizing the enzyme, the coenzyme, and the electron mediator on the subelectrode 11. The resulting negative electrode 1 having the enzyme, the coenzyme, and the electron mediator immobilized thereon permits the enzymatic metabolism to take place efficiently thereon. Alternatively, the negative electrode 1 efficiently converts the enzymatic reaction taking place near the subelectrode 11 into electrical signals. Furthermore, the negative electrode 1 remains stable in any environment of operation and hence provides a high-performance biofuel cell.

A biofuel cell according to a third embodiment will be described below.

The biofuel cell according to the third embodiment includes the proton conductor 3 formed of an electrolyte layer containing a buffer such as a phosphate buffer or a Tris buffer. The concentration of the buffer in the electrolyte layer at least around the enzyme immobilized on the negative electrode 1 and the positive electrode 2 is in the range of 0.2 M to 2.5 M, preferably 0.2 M to 2 M, more preferably 0.4 M 2 M, and still more preferably 0.8 M to 1.2 M. This results in a high buffer capacity. Thus, the optimum pH value, e.g., about 7, for the enzyme, is maintained even during high-power operation of the biofuel cell, thereby fully exhibiting the inherent ability of the enzyme. For example, NaH₂PO₄ and KH₂PO₄ are used as the phosphate buffer.

The biofuel cell according to the third embodiment is the same as in the first embodiment, except for the foregoing description.

According to the third embodiment, the concentration of the buffer material (buffer solution) in the electrolyte layer is in the range of 0.2 M to 2.5 M. In this case, a sufficient buffer capacity is achieved. Thus, the optimum pH value of the electrolyte layer around the enzyme immobilized on the positive electrode 2 and the negative electrode 1 is maintained even during high-power operation of the biofuel cell, thus fully exhibiting the inherent ability of the enzyme. This results in a high-performance biofuel cell capable of performing high-power operation.

A biofuel cell according to a fourth embodiment will be described below.

In this biofuel cell, starch, which is a polysaccharide, is used as fuel. Thus, glucoamylase, which is a catabolic enzyme that decomposes starch into glucose, is also immobilized on the subelectrode 11.

In the biofuel cell, starch as fuel fed into the negative electrode 1 side is hydrolyzed by glucoamylase into glucose. The resulting glucose is decomposed by glucose dehydrogenase. An oxidation reaction in the decomposition process involves a reduction reaction of NAD⁺ into NADH. The resulting NADH is oxidized by diaphorase into two electrons, NAD⁺, and H⁺. In other words, one molecule of glucose yields two electrons and two protons in a single oxidation step. In two oxidation steps, four electrons and four protons are produced in total. The resulting electrons are transferred to the subelectrode 11 of the negative electrode 1. The resulting protons are transferred to the positive electrode 2 through the proton conductor 3. At the positive electrode 2, the protons react with oxygen that is fed into the positive electrode from the outside and the electrons that are transferred from the negative electrode through an external circuit to form water.

The biofuel cell according to the fourth embodiment is the same as in the first embodiment, except for the foregoing description.

The fourth embodiment offers not only the same advantage as the first embodiment but also the additional advantage that starch as fuel produces more electrical power than glucose as fuel.

While the embodiments have been described above, the present application is not limited to the above-described embodiments.

For example, the values, structures, constitutions, shapes, materials, and the like described in the embodiments are merely examples. Different values, structures, constitutions, shapes, and materials from those described above may be used, as needed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fuel cell comprising:
a positive electrode;
a negative electrode;
an enzyme including an oxidase that oxidizes a monosaccharide, the enzyme being immobilized on the negative electrode;
an electron mediator including a compound having a naphthoquinone skeleton, the electron mediator being immobilized on the negative electrode;
a coenzyme that is formed by oxidation of the monosaccharide; and
a coenzyme oxidase that oxidizes the coenzyme,
wherein the ratio of the electron mediator to the coenzyme is in the range of 1.0 (mol):0.33 (mol) to 1.0 (mol):1.0 (mol).

2. The fuel cell according to claim 1,
wherein the ratio of the oxidase to the coenzyme oxidase is (1.8 to 3.6)×10⁶ (U):(0.85 to 1.7)×10⁷ (U).

3. The fuel cell according to claim 2,
wherein the electron mediator, the coenzyme, the oxidase, and the coenzyme oxidase are immobilized on the negative electrode.

4. The fuel cell according to claim 1,
wherein the compound having the naphthoquinone skeleton is 2-methyl-1,4-naphthoquinone.

5. The fuel cell according to claim 1,
wherein the coenzyme is NADH,
the oxidized form of the coenzyme is NAD⁺, and
the coenzyme oxidase is NADH dehydrogenase.

6. The fuel cell according to claim 1,
wherein the oxidase is glucose dehydrogenase, and
the coenzyme oxidase is diaphorase.

7. The fuel cell according to claim 1,
wherein the enzyme includes
a catabolic enzyme that decomposes a polysaccharide into a monosaccharide, and
an oxidase that decomposes a monosaccharide.

8. The fuel cell according to claim 7,
wherein the catabolic enzyme is glucoamylase, and
the oxidase is glucose dehydrogenase.

9. The fuel cell according to claim 1, further comprising:
a proton conductor or a separator arranged between the positive electrode and the negative electrode.

10. A method for producing a fuel cell that includes:
a positive electrode,
a negative electrode,
an enzyme including an oxidase that oxidizes a monosaccharide, the enzyme being immobilized on the negative electrode,
an electron mediator including a compound having a naphthoquinone skeleton, the electron mediator being immobilized on the negative electrode,
a coenzyme that is formed by oxidation of the monosaccharide, and
a coenzyme oxidase that oxidizes the coenzyme, the method comprising:
immobilizing the electron mediator on the negative electrode in such a manner that the ratio of the electron mediator to the coenzyme is in the range of 1.0 (mol):0.33 (mol) to 1.0 (mol):1.0 (mol).

11. The method according to claim 10,
wherein the compound having the naphthoquinone skeleton is immobilized on the negative electrode with acetone.

12. A method for producing a fuel cell that includes
a positive electrode,
a negative electrode,
an enzyme including an oxidase that oxidizes a monosaccharide, the enzyme being immobilized on the negative electrode,
an electron mediator including a compound having a naphthoquinone skeleton, the electron mediator being immobilized on the negative electrode,
a coenzyme that is formed by oxidation of the monosaccharide, and
a coenzyme oxidase that oxidizes the coenzyme, the method comprising:
immobilizing the enzyme on the negative electrode in such a manner that the ratio of the oxidase to the coenzyme oxidase is (1.8 to 3.6)×10⁶ (U):(0.85 to 1.7)×10⁷ (U).

13. The method according to claim 12,
wherein the compound having the naphthoquinone skeleton is immobilized on the negative electrode with acetone.

14. An electronic device comprising:
a fuel cell including
a positive electrode,
a negative electrode,
an enzyme including an oxidase that oxidizes a monosaccharide, the enzyme being immobilized on the negative electrode,
an electron mediator including a compound having a naphthoquinone skeleton, the electron mediator being immobilized on the negative electrode,
a coenzyme that is formed by oxidation of the monosaccharide, and
a coenzyme oxidase that oxidizes the coenzyme,
wherein the ratio of the electron mediator to the coenzyme is in the range of 1.0 (mol): 0.33 (mol) to 1.0 (mol):1.0 (mol).

15. The electronic device according to claim 14,
wherein the ratio of the oxidase to the coenzyme oxidase is (1.8 to 3.6)×10⁶ (U):(0.85 to 1.7)×10⁷ (U).
